(19) United States
(12) Patent Application Publication
(10) Pub. No.: US 2016/0165039 A1
(43) Pub. Date: Jun. 9, 2016

(54) TERMINAL DEVICE

(71) Applicant: SHARP KABUSHIKI KAISHA, Osaka-shi, Osaka (JP)

(72) Inventor: Sayori Arai, Osaka-shi (JP)

(21) Appl. No.: 14/903,802

(22) PCT Filed: Jul. 9, 2014
(86) PCT No.: PCT/JP2014/068256

§ 371 Date: Jan. 8, 2016

(30) Foreign Application Priority Data
Aug. 2, 2013 (JP) 2013-161708

(51) Int. Cl. H04M 1/725

(52) U.S. Cl. CPC H04M 1/72569; H04M 1/7253

(57) ABSTRACT

A terminal device provided with: a display unit; a hold state detection unit that detects a contact or proximity of a hand to the display unit; and a short-distance wireless communication function switching unit that switches a short-distance wireless communication function on or off in accordance with a result of detection by the hold state detection unit.

### TECHNICAL FIELD

The present invention relates to a terminal device, and particularly to a terminal device with a short-distance wireless communication function.

### BACKGROUND ART

The opportunities for using short-distance wireless communication (such as Near Field Communication or NFC) on portable terminal devices, such as smartphones, are increasing. When short-distance wireless communication is used, a user needs to activate the short-distance wireless communication function through a manual operation.

A portable terminal device described in Patent Literature 1 indicated below includes: a grip sensor unit that generates a sensor signal based on a holding of the device by a user for performing electric power control for SAR reduction depending on the device-held environment; a control unit that performs communication means power supply control and/or communication means antenna module tuning control by detecting a grip sensor pattern based on the sensor signal supplied from the grip sensor unit and by detecting control information for a communication means corresponding to the detected grip sensor pattern; and the communication means for which power supply control or antenna module tuning is performed according to control supplied to the control unit.

A portable terminal device described in Patent Literature 2 indicated below includes a housing with a touch sensor disposed on each of opposite left-side and right-side surfaces of the housing, the touch sensor region being divided into a plurality of sensor regions. The portable terminal device is provided with an operating unit and a control unit. The operating unit, responsive to operation information associated with the touch sensor being touched by a finger, supplies an on-signal to the control unit on a sensor region by sensor region basis. The control unit, on the basis of the on-signals supplied on a sensor region by sensor region basis, determines the number of fingers that have touched the touch sensors, and executes a different process in accordance with the determined number of the fingers. Depending on a plurality of touch patterns detected by the touch sensors, various processes can be executed.

### CITATION LIST

### Patent Literature

Patent Literature 1: JP 2012-170071 A

Patent Literature 2: JP 2011-119959 A

### SUMMARY of INVENTION

### Technical Problem

However, the literatures do not disclose a technology for switching between activation and deactivation of the short-distance wireless communication function even without a conscious effort by the user.

An object of the present invention to provide a terminal device that eliminates the need for an operation for activating the short-distance wireless function and that provides a high level of convenience.

### Solution to Problem

According to the present invention, when the short-distance wireless communication is used, a state of the terminal being held such that the screen is hidden is detected, and, upon detection of a state of the screen portion being hidden by a predetermined ratio or more, the short-distance wireless communication function is activated.

According to an aspect of the present invention, there is provided a terminal device including a display unit; a hold state detection unit that detects a contact or proximity of a hand to the display unit; and a short-distance wireless communication function switching unit that activates a short-distance wireless communication function in accordance with the detection by the hold state detection unit of the contact or proximity of the hand to the display unit.

Because an antenna for short-distance wireless communication is basically disposed on the opposite side from the screen of the display unit, the screen becomes hidden without a conscious effort by the user when the device is held for using the relevant function. The short-distance wireless communication function is activated upon detection of that state, thereby eliminating the need for a special operation.

The present invention also provides a control method for a terminal device including a display unit and a hold state detection unit that detects a contact or proximity of a hand to the display unit, the method comprising a short-distance wireless communication function switching step of activating a short-distance wireless communication function in accordance with the detection by the hold state detection unit of the contact or proximity of the hand to the display unit.

The present description includes the contents described in the description and/or drawings of Japanese patent application No. 2013-161708 forming the basis for the claim of priority of the present application.

### Advantageous Effects of Invention

According to the present invention, when short-distance wireless communication is used, the function is activated simply by holding the terminal device from a direction such that the display unit is hidden. Thus, the trouble of having to perform a manual switching operation for activating the short-distance wireless communication function can be advantageously eliminated.

Further, the short-distance wireless communication function is activated only when necessary, thus saving electric power.

### BRIEF DESCRIPTION OF DRAWINGS

FIG. 1 is a functional block diagram of a configuration example of a smartphone as an example of the portable terminal according to an embodiment of the present invention.

FIG. 2 is a diagram of an exterior configuration example of the smartphone.

FIG. 3 is a flowchart of the flow of a process.

FIG. 4 illustrates an example of short-distance wireless communication being performed between the portable terminal held by a user's hand and an NFC tag.

FIG. 5 is a chart for describing by way of example how a determination is made by a hold region determination unit, the chart showing a relationship between a detection value X based on a capacitive touch panel and a coverage region Y.

FIG. 6 illustrates an example of short-distance wireless communication being performed between the portable terminal device according to a fourth embodiment of the present invention that is held by a user's hand and an NFC tag, the figure corresponding to FIG. 4.

### DESCRIPTION OF EMBODIMENTS

In the following, a terminal device according to embodiments of the present invention will be described with reference to the drawings.

### First Embodiment

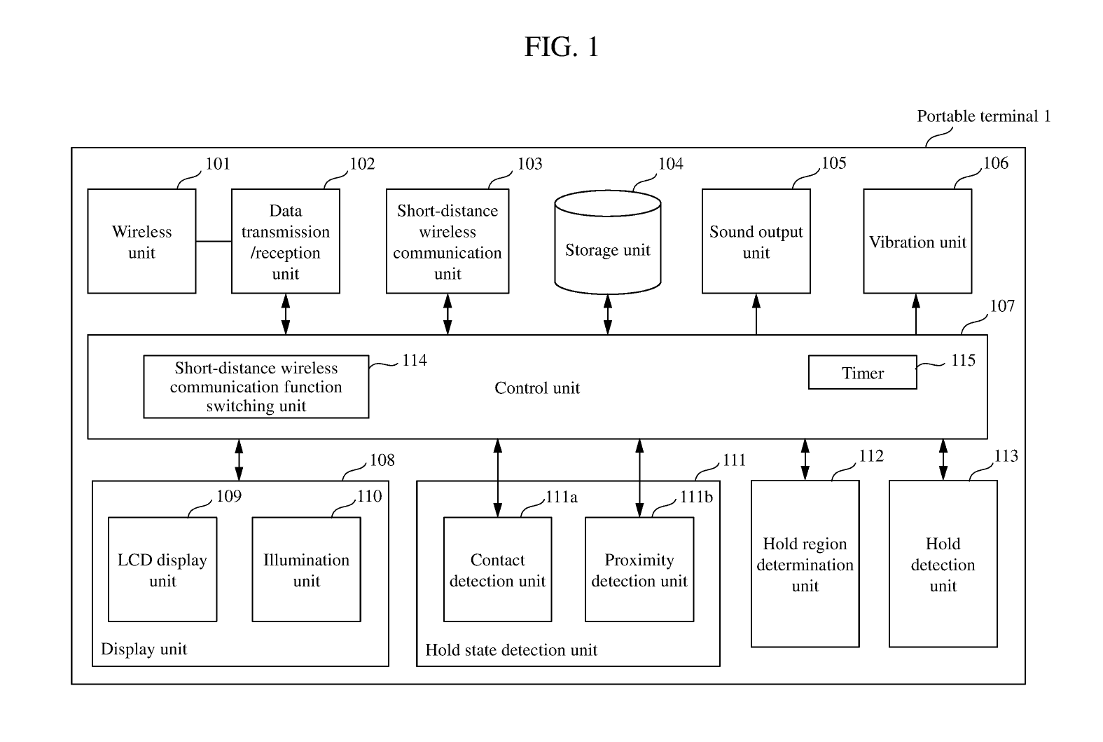

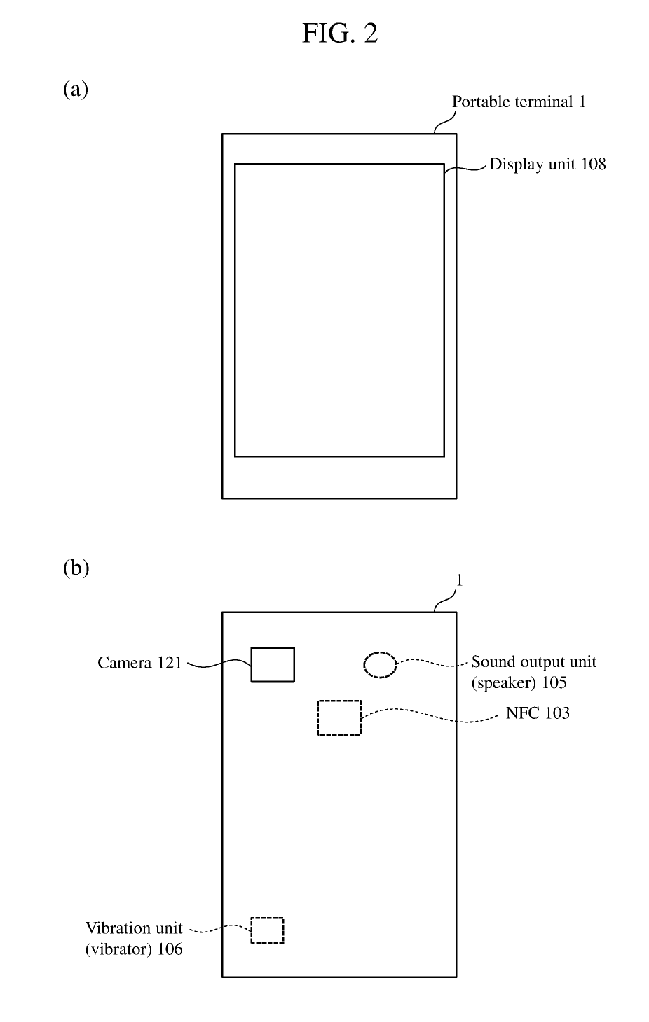

A first embodiment of the present invention will be described. FIG. 1 is a functional block diagram of a configuration example of a portable terminal (which may include a terminal device such as a personal computer, or a portable telephone device, as well as a smartphone as described herein) as an example of the terminal device according to the embodiment of the present invention. FIG. 2 illustrates an exterior configuration example of the smartphone.

The portable terminal 1 according to the present embodiment includes a wireless unit 101 for wireless communication and a data transmission/reception unit 102, and is capable of performing data communication including voice and packets and the like wirelessly via a network. The portable terminal 1 also includes a short-distance wireless communication unit 103 for performing short-distance wireless communication that can be utilized for, e.g., data transmission and reception between NFC-mounted terminals, such as for Android Beam, or for reading or writing of information in an IC chip, such as an NFC tag; a storage unit 104 in which setting contents of the portable terminal 1, acquired data and the like are stored; a sound output unit 105 that outputs sound; a vibration unit (vibrator) 106 that vibrates the portable terminal 1; and a control unit 107 that controls the portable terminal 1 as a whole.

The portable terminal 1 further includes a display unit 108 for displaying data and the like. The display unit 108 includes, e.g., an LCD display unit 109 and an illumination unit 110, such as a liquid crystal backlight.

The portable terminal 1 also includes a hold detection unit 113 that detects a holding of the portable terminal 1, and a hold state detection unit 111 that detects a state of the portable terminal 1 being held. The hold state detection unit 111 includes, e.g., a contact detection unit 111a that senses a hand contacting the display unit 108 of the portable terminal 1, and a proximity detection unit 111b that detects a proximity of a hand to the display unit 108. The portable terminal 1 may also include a hold region determination unit 112 that determines a region of the portable terminal 1 that is being held (a region of the display unit 108 that is covered by the hand). The hold detection unit 113 is used to detect the state of the portable terminal 1 being held by the hand.

The control unit 107 includes a short-distance wireless communication function switching unit 114 which is a switching unit for activating or deactivating the short-distance wireless communication unit 103. The control unit 107 also includes a timer 115 for counting time.

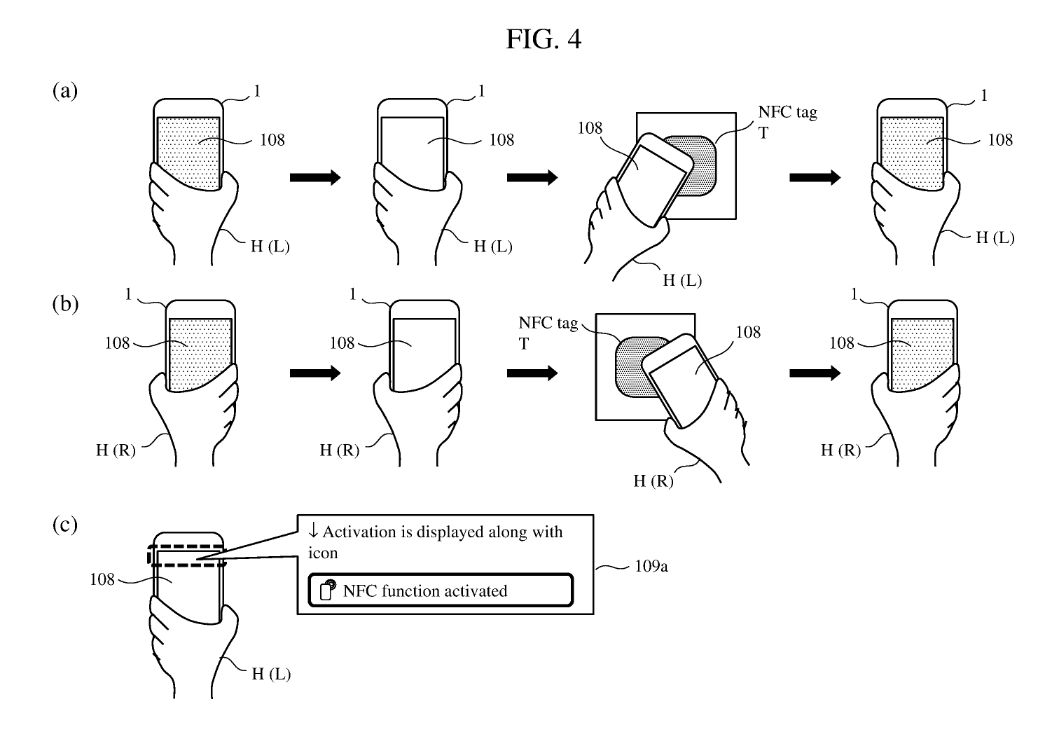

FIG. 2(a) is a front view of the portable terminal 1, showing the display unit 108 mounted on a housing. FIG. 2(b) is a rear view of the portable terminal 1, showing, e.g., the short-distance wireless communication unit (NFC) 103, a camera 121, the sound output unit (speaker) 105, and the vibration unit (vibrator) 106 that are mounted. A user can perform communication by holding the portable terminal 1 from the front and placing the NFC 103 on the back close to a counterpart device for short-distance communication. FIG. 4 illustrates examples of performing short-distance communication between the portable terminal 1 being held by the user's hand H and an NFC tag T when, for example, reading coupon information from the NFC tag T affixed to a poster, reading information in an IC chip contained in a card and the like, or reading information from the NFC tag placed in the house or a car to modify the setting of the portable terminal 1.

According to the present embodiment, the contact detection unit 111a and/or the proximity detection unit 111b is used as the hold state detection unit 111, and the units are implemented with a capacitive touch panel.

For example, when the contact detection unit 111a is used, it is determined whether there is a contact as on a normal touch panel, and a detection is made based on whether the screen is being contacted by the hand from one direction, as shown in FIG. 4. When the proximity detection unit 111b is used, a contact state and a proximate state are distinguished based on a difference in capacitance, and a detection is further made based on whether the hand is proximate to the screen as a whole from one direction. The contact detection unit 111a and the proximity detection unit 111b may be used in combination to detect a hold state as to whether the terminal is being held such that the screen is hidden from one direction, on the basis of both the contact state and the proximate state.

The hold detection unit 113 may also be implemented with a capacitive sensor. In this case, the hand-held state can be detected based on a change in capacitance.

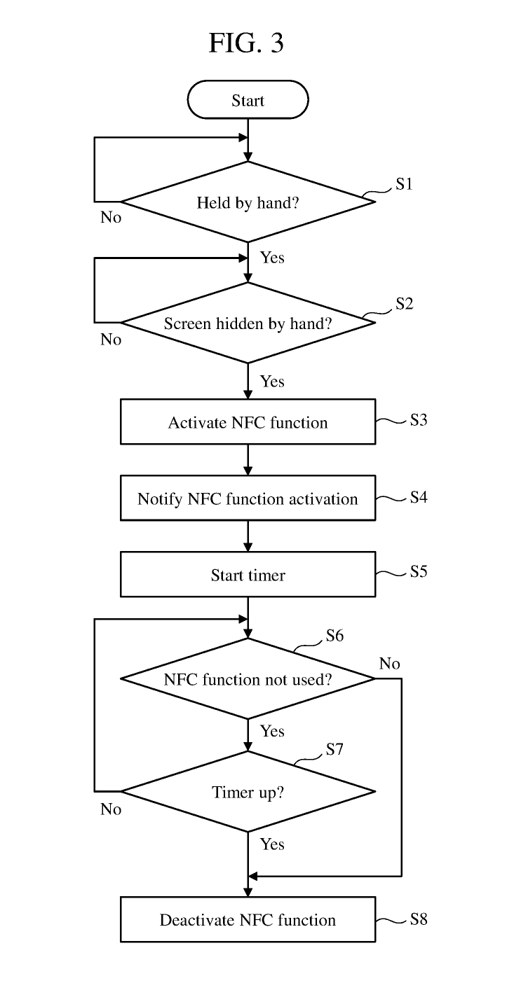

FIG. 3 is a flowchart of the flow of a process.

When the state of the portable terminal 1 being held by hand is detected by the hold detection unit 113 (Yes in step S1), and the state of the screen portion of the LCD display unit 109 being hidden by hand is detected by the hold state detection unit 111 (Yes in step S2), the short-distance wireless communication function switching unit 114 activates the NFC function (step S3). The activation of the NFC function is notified by, e.g., the LCD display unit 109 or the illumination unit 110 of the display unit 108, or by the sound output unit 105 or the vibration unit 106 (step S4), and the timer 115 is started (step S5). As the timer 115 is started, it is determined whether the NFC function has been used (step S6), and the determination is made until the timer 115 is up (step S7). If it is determined that the NFC function has been used (No in step S6) or when the timer is up (Yes in step S7), the NFC function is deactivated by the short-distance wireless communication function switching unit 114 (step S8).

More specifically, FIG. 4(a) illustrates an example in which the portable terminal 1 is held by a left hand (H(L)), and FIG. 4(b) illustrates an example in which the portable terminal 1 is held by a right hand (H(R)). A common description for both (a) and (b) is as follows.

1) When the portable terminal 1 such as a smartphone is held by the hand H in such a manner that the screen (the display unit 108) is hidden, 2) the NFC function is activated, whereby the illumination unit 110 (backlight) of the display unit 108 is turned on. As illustrated in FIG. 4(c), a notice 109a indicating the activation of the NFC function may be displayed in an icon portion in addition to the lighting of the illumination unit 110, so that the activation of the NFC function can be unmistakably indicated. 3) In response to the notification of activation of the NFC function, as the portable terminal 1 being held is touched or placed in proximity to the NFC tag T, an operation described in the NFC tag T, such as an instruction for starting WiFi, is read, whereby a WiFi starting process, e.g., is automatically executed. 4) Since the NFC function has been utilized in 3), the NFC function is deactivated. At this time, the illumination unit 110 (backlight) of the display unit 108 may be turned off to notify the user about the deactivation.

As described above, the portable terminal according to the present embodiment includes a hold detection unit, such as a electrostatic sensor, that detects whether the portable terminal is in a state of being held by hand; a hold state detection unit, such as an electrostatic sensor, for determining whether, when the portable terminal is held by hand, the display screen is being hidden by hand; and a short-distance wireless communication function switching unit that switches on the NFC function upon detection of the hiding. Thus, when the short-distance wireless communication is used, the function can be activated by simply holding the terminal from a direction such that the screen is hidden, without having to perform a manual switching operation, whereby the need for bothersome operations and the like can be advantageously eliminated. Generally, an antenna for short-distance wireless communication is disposed on the opposite side from the display screen, so that the screen becomes hidden without a conscious effort by the user when the device is held for using the function. There is also the advantage of saving electric power because the NFC function is activated only when the short-distance wireless communication function is required.

### Second Embodiment

The portable terminal according to a second embodiment of the present invention will be described.

As the basic configuration is similar to that of the first embodiment, the following description will focus mainly on differences therefrom.

The first embodiment is further provided with the hold region determination unit 112 that determines, with respect to the detection result in step S2 of FIG. 3, a ratio of the contact or proximity to the entire screen region of the LCD display unit 109 provided with the hold state detection unit 111 configured from a capacitive touch panel and the like, i.e., a coverage ratio, and to determine whether the determined coverage ratio is equal to or greater than a predetermined value (FIG. 1).

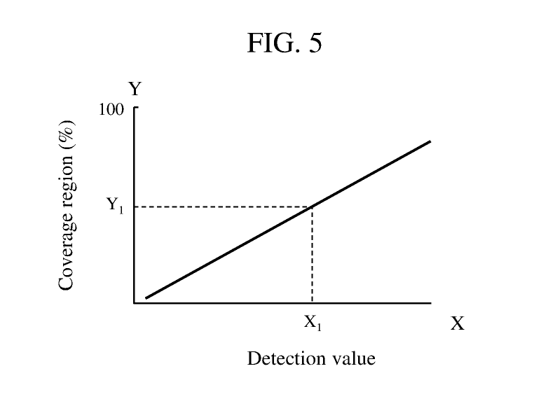

FIG. 5 is a chart illustrating how the determination is made by the hold region determination unit 112, showing a relationship between a detection value X based on the capacitive touch panel and a coverage region Y. The greater the detection value X based on the capacitive touch panel, the greater the ratio of the coverage region becomes. For example, when the predetermined ratio is Y₁ (such as 50%), the hand-held state is determined when the detection value is equal to or greater than X₁. Then, it is determined that there is the state of the portable terminal 1 shown in FIG. 4 being held from the LCD display unit 109 side, i.e., a state indicating an intention of using the NFC function, and the short-distance wireless communication function switching unit 114 activates the short-distance wireless communication unit 103.

The detection value X of the capacitive touch panel may be determined by, e.g., determining a cross-coupling capacitance, or on the basis of the presence or absence of a touch at a plurality of touch positions provided at different positions.

Thus, according to the present embodiment, the short-distance wireless communication function switching unit activates the short-distance wireless communication function when the detection result based on the capacitive touch panel indicates a predetermined ratio or more of contact or proximity to the region of the LCD display unit. Accordingly, the short-distance wireless communication function of the portable terminal can be switched accurately, whereby the function can be advantageously easily utilized by distinguishing from other uses.

While in the foregoing example, the detection value X is cross-coupling capacitance because of the use of the capacitive touch panel, the detection value may vary depending on the detection means used.

### Third Embodiment

The portable terminal according to a third embodiment of the present invention will be described.

The basic configuration is similar to that of the first and second embodiments. Thus, the following description will focus mainly on differences therefrom.

The present embodiment is characterized in that, when it is determined in step S2 of FIG. 3 whether the screen is hidden by hand, it is determined whether the detection result from the hold state detection unit 111 indicates that the operator's hand is in the same state for a certain time or longer as counted by the timer 115, and the NFC function is activated only when the same state continues for the certain time, such as one second, or longer, thus detecting a difference from more general input operations on the touch panel involving the hand state changing in a shorter time.

Thus, according to the present embodiment, the NFC function is activated by the short-distance wireless communication function switching unit only when the detection result from the hold state detection unit indicates that the state of the operator's hand is in the same state for a certain time, so that the switching operation is not performed in the case of more general input operations. In this way, the short-distance wireless communication function of the portable terminal can be switched accurately and easily utilized while making a distinction from other uses.

### Fourth Embodiment

The portable terminal according to a fourth embodiment of the present invention will be described.

The basic configuration is similar to that of the first to third embodiments. Thus, the following description will focus mainly on differences therefrom.

The present embodiment is characterized in that the activation of the NFC function in step S4 of FIG. 3 is notified using the sound output unit (speaker) 105 and/or the vibration unit (vibrator) 106 shown in FIG. 1.

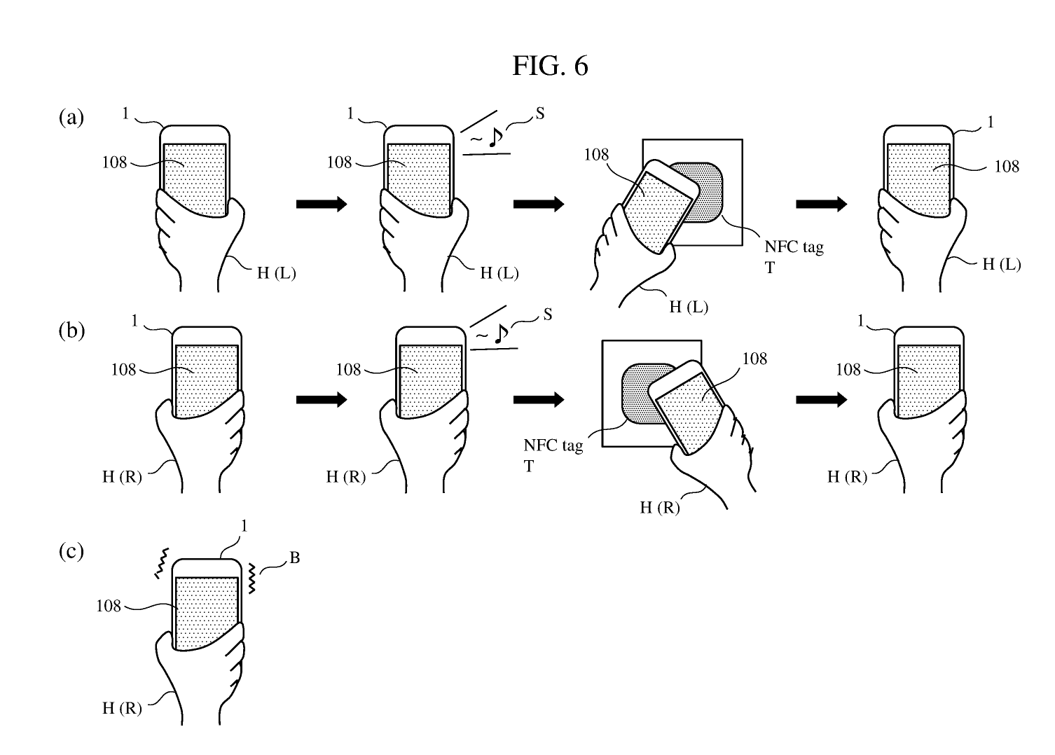

FIG. 6 is a diagram for the present embodiment, corresponding to FIG. 4.

Specifically, FIG. 6(a) illustrates an example in which the portable terminal 1 is held by the left hand (H(L)), and FIG. 6(b) illustrates an example in which the portable terminal 1 is held by the right hand (H(R)). Both (a) and (b) may be commonly described as follows.

1) When the portable terminal 1 such as a smartphone is held by the hand H in such a manner that the screen (display unit 108) is hidden, 2) the NFC function is activated, which is notified by the sound output unit 105 using sound S. The notification may be made via vibration B using the vibration unit 106, as indicated in FIG. 6(c). 3) In response to the notification of the activation of the NFC function, as the portable terminal 1 being held is touched or placed in proximity to the NFC tag T, an operation described in the NFC tag T, such as an instruction for starting WiFi, is read, whereby a WiFi starting process, e.g., is automatically executed. 4) As the NFC function has been utilized in 3), the NFC function is deactivated. At this time, the user may be notified of the deactivation via the sound output unit 105 or the vibration unit 106.

The notification may be made by only one of the methods or by an arbitrary combination of the methods.

As the hold detection unit 113 for detecting the state of the portable terminal 1 being held, an electrostatic sensor, a grip sensor and the like may be used. As the hold state detection unit 111 for detecting the state of the screen portion being hidden by a predetermined ratio or more, an electrostatic sensor, a proximity sensor (touch panel (hover), sound (ultrasonic), illuminance), a camera and the like may be used.

In the following, examples will be described; however, the present invention is not limited to the examples.

### 1) EXAMPLE 1

In Example 1, the contact detection unit 111a is implemented with a capacitive touch panel as in the first embodiment, and the proximity detection unit 111b is implemented with an ultrasonic sensor. The ultrasonic sensor used as the proximity detection unit 111b transmits ultrasound waves and receives its reflected waves to detect the proximity of a hand to the portable terminal 1.

### 2) EXAMPLE 2

In Example 2, the contact detection unit 111a is implemented with a capacitive touch panel, and the proximity detection unit 111b is implemented with a camera. The camera as the proximity detection unit 111b is disposed in a lower part of the portable terminal 1 in addition to the conventional in-camera, so that it can be determined, based on an image taken by the camera, whether the terminal is being held in such a manner that the screen is hidden. The hold detection unit 113 is implemented with a grip sensor so as to detect the hand-held state on the basis of a pressure applied to the portable terminal 1.

### 3) EXAMPLE 3

In Example 3, the contact detection unit 111a is implemented with a capacitive touch panel, and the proximity detection unit 111b is implemented with illuminance sensors. The illuminance sensors of the proximity detection unit 111b are disposed at several locations vertically of the portable terminal 1 so as to determine whether, based on the state of illuminance, the terminal is being held such that the screen is hidden by hand. The hold detection unit 113 is implemented with a capacitive sensor so as to detect the hand-held state on the basis of a capacitance change.

In the first to fourth embodiments, the hold detection unit 113 may be implemented with an acceleration sensor so as to determine the hand-held state by detecting a tilting motion (wobble) of the portable terminal device.

The processes and controls may be implemented by software processing using a CPU (Central Processing Unit) or a GPU (Graphics Processing Unit), or by hardware processing using an ASIC (Application Specific Integrated Circuit) or a FPGA (Field Programmable Gate Array).

It should be noted that, with respect to the foregoing embodiments, the configurations and the like shown in the attached drawings do not limit the present invention and may be modified as needed within the scope such that the effects of the present invention can obtained. Various modifications may be made as needed without departing from the scope of the purpose of the present invention.

The constituent elements of the present invention may be deleted or selected as needed, and an invention provided with the deleted or selected configurations is also included in the present invention.

A program for implementing the functions described with reference to the embodiments may be recorded in a computer-readable recording medium, and the program recorded in the recording medium may be read by a computer system and executed to perform the processes of the various units. The “computer system” herein includes as an OS and hardware such as peripheral devices and the like.

The “computer system”, when using a WWW system, may include a Web page-providing environment (or displaying environment).

The “computer-readable recording medium” refers to, e.g., a portable medium such as a flexible disc, a magneto-optic disc, a ROM, or a CD-ROM, or a storage device built inside the computer system, such as a hard disk. The “computer-readable recording medium” also includes a medium that dynamically holds a program for a short time, such as a communication line for transmitting the program via a network, such as the Internet, or a communication line, such as a telephone line, and a volatile memory inside a computer system serving as a server or a client in that case. The program may be for implementing some of the functions, or for implementing the functions in combination with a program that is already recorded in the computer system. At least some of the functions may be implemented using hardware such as an integrated circuit.

### (Notes)

The present invention includes the following disclosures.

(1)

A terminal device comprising: a display unit; a hold state detection unit that detects a contact or proximity of a hand to the display unit; and a short-distance wireless communication function switching unit that activates a short-distance wireless communication function in accordance with the detection by the hold state detection unit of the contact or proximity of the hand to the display unit.

Because a short-distance wireless communication function unit is basically disposed on the opposite side from the screen of the display unit, the screen becomes hidden without a conscious effort by the user when the device is held for using the relevant function. The short-distance wireless communication function is activated upon detection of that state, thus eliminating the need for a special operation.

(2)

The terminal device described in (1), further comprising a hold region determination unit that determines a ratio of a contact or proximity region on the display unit and determines whether the determined ratio is equal to or greater than a predetermined value, wherein the short-distance wireless communication function switching unit activates the short-distance wireless communication function when, based on a result of determination by the hold region determination unit, a coverage ratio is equal to or greater than the predetermined value.

Thus, an advantage can be obtained that the short-distance wireless communication function can be switched accurately in the terminal device and easily utilized while distinguishing from other uses.

(3)

The terminal device described in (1) or (2), wherein the short-distance wireless communication function switching unit determines whether the result of detection by the hold state detection unit indicates that a state of the operator's hand is in the same state for a certain time or longer, and activates the short-distance wireless communication function only when the hand state is in the same state for the certain time or longer.

By disabling the switching operation in the case of general input operations, the short-distance wireless communication function can be switched accurately in the portable terminal device and advantageously easily used while distinguishing from other uses.

(4)

The terminal device described in any one of (1) to (3), further comprising a hold detection unit that detects a holding of the terminal device, wherein the hold state detection unit performs detection when the holding of the terminal is detected by the hold detection unit.

By detecting the hold state when the terminal is held, erroneous operation can be prevented.

(5)

The terminal device according to any one of (1) to (4), comprising a timer that is started upon switching for activation of the function by the short-distance wireless communication function switching unit, wherein the timer counts a period before the function is deactivated by the short-distance wireless communication function switching unit in the absence of use of the short-distance wireless communication function in a predetermined period.

Because the NFC function is activated only in a period in which the short-distance wireless communication function is required, electric power can be advantageously saved.

(6)

The terminal device according to any one of (1) to (5), comprising a notification unit that notifies the switching for activation of the short-distance wireless communication function by the short-distance wireless communication function switching unit.

The user can confirm the operation of the switching function.

(7)

A control method for a terminal device including a display unit and a hold state detection unit that detects a contact or proximity of a hand to the display unit, the method comprising a short-distance wireless communication function switching unit step of activating a short-distance wireless communication function in accordance with the detection by the hold state detection unit of the contact or proximity of the hand to the display unit.

(8)

A program for causing a computer to execute the control method described in (7).

(9)

A computer-readable recording medium having the program described in (8) recorded therein.

### INDUSTRIAL APPLICABILITY

The present invention can be utilized in portable terminal devices.

### REFERENCE SIGNS LIST

1 Portable terminal
101 Wireless unit
102 Data transmission/reception unit
103 Short-distance wireless communication unit
104 Storage unit
105 Sound output unit
106 Vibration unit (vibrator)
107 Control unit
108 Display unit
109 LCD display unit
110 Illumination unit
111 Hold state detection unit
111a Contact detection unit
111b Proximity detection unit
112 Hold region determination unit
113 Hold detection unit

All publications, patents, and patent applications cited in the present description are incorporated herein by reference in their entirety.

1-5 (canceled)

6. A terminal device comprising:
a display unit;
a hold state detection unit that detects a contact or proximity of a hand to the display unit; and
a short-distance wireless communication function switching unit that activates a short-distance wireless communication function in accordance with the detection by the hold state detection unit of the contact or proximity of the hand to the display unit.

7. The terminal device according to claim 6, further comprising a hold region determination unit that determines a ratio of a contact or proximity region on the display unit, and determines whether the determined ratio is equal to or greater than a predetermined value,
wherein the short-distance wireless communication function switching unit activates the short-distance wireless communication function when, based on a result of determination by the hold region determination unit, a coverage ratio is equal to or greater than the predetermined value.

8. The terminal device according to claim 6, wherein the short-distance wireless communication function switching unit determines whether, based on a result of detection by the hold state detection unit, a state of an operator's hand is in the same state for a certain time or longer, and activates the short-distance wireless communication function only when the same state continues for the certain time or longer.

9. The terminal device according to claim 7, wherein the short-distance wireless communication function switching unit determines whether, based on a result of detection by the hold state detection unit, a state of an operator's hand is in the same state for a certain time or longer, and activates the short-distance wireless communication function only when the same state continues for the certain time or longer.

10. The terminal device according to claim 6, further comprising a hold detection unit that detects a holding of the terminal device,
wherein the hold state detection unit performs detection when the holding of the terminal is detected by the hold detection unit.

11. The terminal device according to claim 6, further comprising a timer that is started upon switching for activation of the function by the short-distance wireless communication function switching unit, wherein the timer counts a period before the function is deactivated by the short-distance wireless communication function switching unit in the absence of use of the short-distance wireless communication function within a predetermined period.

12. The terminal device according to claim 6, further comprising a notification unit that notifies the switching for activation of the short-distance wireless communication function by the short-distance wireless communication function switching unit.

13. A control method for a terminal device including a display unit and a hold state detection unit that detects a contact or proximity of a hand to the display unit, the method comprising a short-distance wireless communication function switching unit step of activating a short-distance wireless communication function in accordance with the detection by the hold state detection unit of the contact or proximity of the hand to the display unit.

14. A non-transitory computer-readable recording medium including a computer program that causes a computer to perform the control method according to claim 13.
